(19) United States
(12) Patent Application Publication
(10) Pub. No.: US 2005/0180724 A1
(43) Pub. Date: Aug. 18, 2005

(54) Optical filter as well as optical arrangement with such a filter

(76) Inventor: Georg Diamantidis, Dernbach (DE)

Correspondence Address: YOUNG & BASILE, P.C., 3001 WEST BIG BEAVER ROAD, SUITE 624, TROY, MI, 48084, US

(21) Appl. No.: 11/040,121

(22) Filed: Jan. 21, 2005

(30) Foreign Application Priority Data
Aug. 1, 2003 (EP) 017430.4

(51) Int. Cl. G02B 6/00

(52) U.S. Cl. 385/147

(57) ABSTRACT

An optical filter has, in addition to a pass-band in the wavelength range of chlorophyll fluorescence between about 650 and at least 800 nm, an additional pass-band in a wavelength range of about 520 to about 560 nm. The additional pass-band serves to utilize the physiological peculiarity of the human eye that it is “switched” into a greater sensitivity in darkness by green radiation in the wavelength range around 540 nm, which greater sensitivity then also benefits the detection of chlorophyll fluorescence. Radiation in the wavelength range around 540 nm always passes proportionately through the filter, as a result of which the detection of chlorophyll fluorescence is markedly facilitated. The same filter may also be used for the observation of the green image that is produced by conventional night-vision appliances.

The invention relates to an optical filter having a pass-band in the spectral range of chlorophyll fluorescence between about 650 nm and at least 800 nm and having at least one additional pass-band in a short-wave range as well as an optical device comprising such a filter.

Such a filter is disclosed in DE 39 09 434 C2. The filter used therein has, in addition to the pass-band situated in the red wavelength range, an additional pass-band in a wavelength range between 400 and 525 nm that has its maximum at 470 nm. Said additional pass-band at shorter wavelengths than the wavelengths of chlorophyll fluorescence fulfils two functions. On the one hand, it serves to permit the surroundings, that is to say objects and living things that contain no chlorophyll to appear to the observer in as natural colours as possible. On the other hand, the additional pass-band takes account of the physiological peculiarity of the human eye of being able, in dark surroundings, to be shifted by means of light radiation in a shorter wavelength range into a higher sensitivity state that is effective for the entire wavelength range of visible light, that is to say also for red light.

The filter described in DE 39 09 434 C2 offers a good compromise for exploiting both effects with only one additional pass-band.

The object of the present invention is to develop a filter of the type mentioned at the outset in such a way that it develops a still better efficiency in regard to the increase in the sensitivity of the human eye.

This object is achieved, according to the invention, in that the additional pass-band is situated in a wavelength range of about 520 nm to about 560 nm.

The present invention has made it possible to increase further the sensitization of the human eye by light in the specified wavelength range.

It is advantageous if the additional pass-band has a bandwidth of 10 to 30 nm. A narrow pass-band strongly limits the radiation impinging on the human eye in the wavelength range of green light to wavelengths to which the eye reacts sensitively.

A further optimization occurs if the pass-band has a bandwidth of 20 nm.

If the additional pass-band extends from 530 to 550 nm, the wavelength range that shifts the human eye into a higher sensitivity state is almost optimally targeted.

Preferably, the filter according to the invention has a second additional band that is situated in a wavelength range between about 360 and about 430 nm. As a result of said band, radiation having a blue component that originates from objects not containing chlorophyll passes through the filter, as a result of which said objects are well differentiated from the living plants that radiate red chlorophyll fluorescence.

It is advantageous if the second additional pass-band has a bandwidth of 20 to 40 nm. Thus, passage can be prevented of light that is unnecessary for achieving the desired effect and that would impair the ratio of the intensities of the chlorophyll fluorescence and other light.

Preferably, the second additional band has a bandwidth of only 30 nm. This results in the desired effect with a good ratio of the intensities of chlorophyll fluorescence and other light.

If the second pass-band extends from 380 nm to 410 nm, the filter is further optimized in regard to the distinguishability of chlorophyll-free objects and chlorophyll-containing plants.

It is particularly advantageous if the transmissions of the pass-band in the wavelength range of chlorophyll fluorescence and the additional pass-bands (16, 18) are different. This measure enables the respective transmittances to be optimally matched to one another.

Preferably, the transmission of the pass-band in the wavelength range of chlorophyll fluorescence is between about 52% and about 72%, the transmission of the first additional pass-band is between about 4% and about 12% and the transmission of the second additional pass-band is between about 25% and about 35%. These ratios of the transmissions take into account the two desired effects, the sensitization of the human eye and the distinguishability of objects not containing chlorophyll from plants containing chlorophyll.

If the transmission of the pass-band in the wavelength range of chlorophyll fluorescence is 62%, the transmission of the first additional pass-band is 8% and the transmission of the second additional pass-band is 30%, the transmission ratios are advantageously matched to one another.

A further aspect of the present invention relates to the use of the filter according to the invention in optical devices in order to combine the effect of the filter with better visibility through an optical device. If the filter according to the invention is used in conjunction with such an optical device, weaknesses of the human eye, such as, for example, a limited distance vision and/or night vision, can be overcome.

It is therefore advantageous if the filter according to the invention is used in a field glass in order, for example, to be able, during hunting, to make out game well in thick undergrowth comprising plants containing chlorophyll.

The use of the filter according to the invention in a night-vision appliance comprising a residual-light amplifier results in advantages in regard to a lower strain on the human eye.

Commercial night-vision appliances produce an image appearing green on a phosphorescent screen. A long utilization of such a night-vision appliance at this wavelength may result in an overreaction of the human eye and a corresponding fatigue of the latter. The use of the filter according to the invention in such a night-vision appliance has the result that its normally green image appears reddish-violet to the observer. This image does not strain the human eye so severely as a green image.

Exemplary embodiments of the invention are described in greater detail below with reference to the drawing; in the drawing

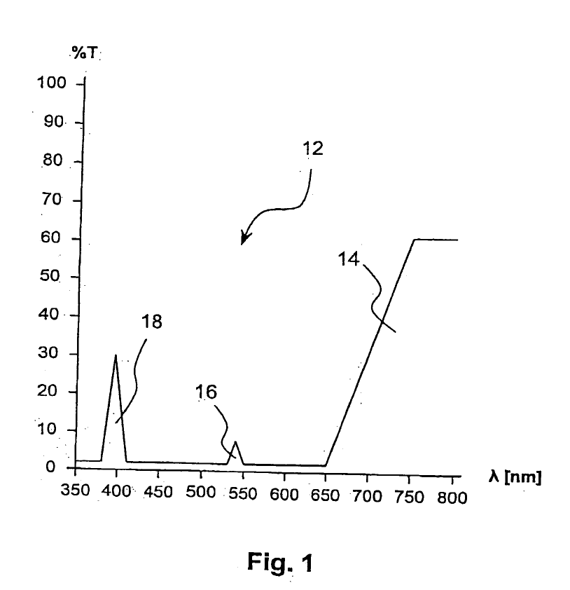

FIG. 1 diagrammatically shows a transmission spectrum of an optical filter for the observation of the environment by the human eye;

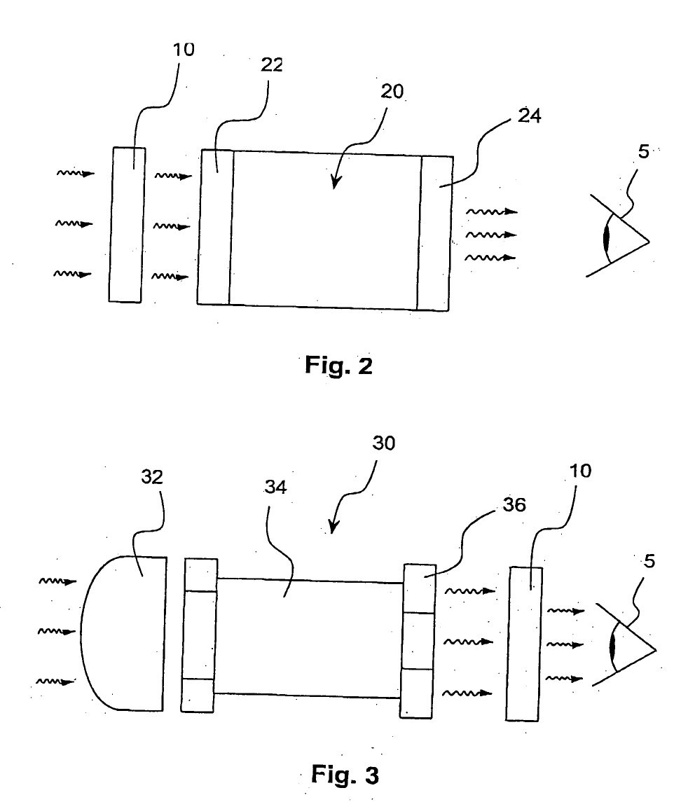

FIG. 2 diagrammatically shows a field glass that comprises the optical filter of FIG. 1; and

FIG. 3 diagrammatically shows a night-vision appliance that comprises the optical filter of FIG. 1.

FIG. 1 shows the transmission spectrum of an optical filter that serves to detect directly by means of the human eye the chlorophyll fluorescence that is emitted by all living plants that contain chlorophyll.

For this purpose, the filter has a pass-band 14 having a relatively high transmittance of 62% in the wavelength range between 650 to at least 800 nm. Chlorophyll fluorescent radiation is situated in said wavelength range.

In addition to the pass-band 14, a first additional pass-band 16 having a markedly lower transmission of 8% extends from 530 nm to 550 nm. A second additional pass-band 18 having a mean transmission of 30% extends from 380 nm to 410 nm.

The pass-band 16 serves to utilize a physiological peculiarity of the human eye advantageously. The human eye has a high sensitivity in the spectral range of green visible light. If, therefore, a light component having a wavelength in the range of green visible light additionally also impinges on the human eye in addition to light having the wavelength of chlorophyll fluorescence in the long-wave range, the sensitivity of the human eye is generally increased considerably and the detection of chlorophyll fluorescence is appreciably better.

In this connection, the green radiation impinging on the human eye should not be too intense since an overreaction of the eye may otherwise occur. This is dealt with yet again below also in regard to FIG. 3.

The deliberate siting of the pass-band 16 in the range from 530 and 550 nm with a relatively low transmittance utilizes the green sensitivity of the human eye almost optimally, as a result of which even only low chlorophyll fluorescences are detectable.

The pass-band 18 fulfils the purpose of obtaining a certain colour impression with different colours in order thus to increase generally the distinguishability of objects.

The filter whose transmission spectrum is shown in FIG. 1 can be used not only for the direct observation of the environment with the eye, but also in combination with visual aids. This is illustrated in FIGS. 2 and 3.

FIG. 2 diagrammatically shows the use of the filter that has the reference symbol 10 therein in a field glass 20. For this purpose, the filter 10 is placed upstream of the input lens 22 of the field glass 20. The properties of the filter are thus combined with an improved distance vision.

The light impinging on the input lens 22 of the field glass 20 has previously passed through the filter 10 and contains only the abovementioned wavelength ranges of the pass-band 14 and of the pass-bands 16, 18. After passing through the eyepiece 24 of the field glass 20, said light impinges on the human eye 5.

In the case of use in a field glass 20, the same effects of the filter 10 become operative that were described above in relation to FIG. 1.

FIG. 3 diagrammatically shows the use of the filter 10 in a night-vision appliance 30.

The night-vision appliance 30 comprises image-forming optics 32, a residual-light amplifier 34 and also a phosphorescent screen 36. Incident radiation is imaged by the image-forming optics 32 on the residual light amplifier 34 and is electronically amplified by the latter. The amplified image is shown in turn on the phosphorescent screen 36 and observed with the human eye.

The filter 10 is disposed between the observer 5 and the phosphorescent screen 36.

Normally, phosphorescent screens used in night-vision appliances produce a green image that may result in rapid fatigue of the human eye.

Since the light delivered by conventional phosphorescent screens also has a red component, the filter 10 has the result that the excessive green component of the phosphorescent screen 32, which green component fatigues the human eye, is very largely, but not completely filtered out. The residual green component is sufficient to utilize the sensitivity of the human eye in this range for a good detection of the image without overstraining and fatiguing the human eye.

The filter 10 has better transmittance for the red component of the radiation delivered by the phosphorescent screen 36 than for green radiation. In the light passing through the filter 10, the intensity ratio of red to green light is therefore displaced in favour of the red light.

This has the consequence that the normally green image of the phosphorescent screen 36, which image severely strains the eye, appears reddish-violet to the observer. This is advantageous especially in the case of a prolonged observation of the image. The overstraining of the colour-sensitive rods of the eye caused by a green image may have the result that the observer sees a green spot for several minutes even after putting down the night-vision appliance 30. Such a reaction does not occur in the case of the more pleasant image that does not strain the eyes and appears reddish-violet.

It is not in fact absolutely necessary for the operation of the filter 10 in a night-vision appliance 30 that the filter 10 has the pass-band 18. Since, however, said pass-band 18 does not restrict the use of the filter 10 in a night-vision appliance 30, it is advantageous to produce a filter that has all three pass-bands 14, 16, 18. This can then be used according to the requirement.

1. Optical filter having a pass-band in the spectral range of chlorophyll fluorescence between about 650 nm and at least 800 nm and having at least one additional pass-band in the short-wave range, characterized in that the additional pass-band is situated in a wavelength range of about 520 nm to about 560 nm.

2. Optical filter according to claim 1, characterized in that the additional pass-band has a bandwidth of 10 to 30 nm.

3. Optical filter according to claim 2, characterized in that the additional pass-band has a bandwidth of 20 nm.

4. Optical filter according to claim 3, characterized in that the additional pass-band extends from 530 nm to 550 nm.

5. Optical filter according to claim 1, characterized in that the filter has a second additional pass-band in a wavelength range from about 360 nm to about 430 nm.

6. Optical filter according to claim 5, characterized in that the second additional pass-band has a bandwidth of 20 to 40 nm.

7. Optical filter according to claim 6, characterized in that the second additional pass-band has a bandwidth of 30 nm.

8. Optical filter according to claim 7, characterized in that the second pass-band extends from 380 nm to 410 nm.

9. Optical filter according to claim 5, characterized in that the transmissions of the pass-band in the wavelength range of chlorophyll fluorescence and the additional pass-bands are different.

10. Optical filter according to claim 9, characterized in that the transmission of the pass-band in the wavelength range of chlorophyll fluorescence is between about 52% and about 72%, the transmission of the first additional pass-band is between about 4% and about 12% and the transmission of the second additional pass-band is between about 25% and about 35%.

11. Optical filter according to claim 10, characterized in that the transmission of the pass-band in the wavelength range of chlorophyll fluorescence is 62%, the transmission of the first additional pass-band is 8% and the transmission of the second additional pass-band is 30%.

12. Optical device, characterized in that it comprises an optical filter according to claim 9.

13. Optical device according to claim 12, characterized in that it is a field glass.

14. Optical device according to claim 12, characterized in that it is a night-vision appliance comprising a residual-light amplifier.
